(19) United States
(12) Patent Application Publication
(10) Pub. No.: US 2026/0097811 A1
(43) Pub. Date: Apr. 9, 2026

(54) VEHICLE BODY ASSEMBLY

(71) Applicants: Hyundai Motor Company, Seoul (KR); Kia Corporation, Seoul (KR)

(72) Inventors: Byeong Cheon Lee, Hwaseong-si (KR); Ji Woong Park, Hwaseong-si (KR)

(21) Appl. No.: 19/194,723

(22) Filed: Apr. 30, 2025

(30) Foreign Application Priority Data
Oct. 8, 2024 (KR) 10-2024-0136831

(51) Int. Cl. B62D 21/15; B60K 1/04; H01M 50/242; H01M 50/249; H01M 50/271

(52) U.S. Cl. CPC B62D 21/155; B60K 1/04; H01M 50/242; H01M 50/249; H01M 50/271; H01M 2220/20

(57) ABSTRACT

A vehicle body assembly can include a slider disposed under a front floor of a body of a vehicle and configured to cover a front side of a battery, and a rear cross member disposed at a rear of the slider and coupled to a lower portion of the front floor of the vehicle body under the front floor to support the slider at the rear of the slider. When collision of the vehicle occurs, the vehicle body assembly can prevent application of impact to a battery caused by a front sub-frame.

### CROSS-REFERENCE TO RELATED APPLICATIONS

This application claims priority from Korean Patent Application No. 10-2024-0136831 filed on Oct. 8, 2024 in the Korean Intellectual Property Office, the disclosure of which is incorporated herein by reference in its entirety.

### TECHNICAL FIELD

The present disclosure relates to a vehicle body assembly.

### BACKGROUND

Generally, a vehicle is constituted by a body and a chassis. The chassis is constituted by a main frame and a sub-frame. The sub-frame disposed under the body at a rear side of the body functions to support an engine, a transmission, an electric motor, a gear box, etc. and to achieve easy load transfer while securing structural rigidity of the vehicle. It is preferred that the front sub-frame be mounted to sufficiently secure basic performance of the vehicle, such as collision performance, noise, vibration and harshness (NVH) performance, ride and handling (R&H) performance, etc.

An electric vehicle includes a battery disposed under a front floor of a vehicle body, and electric driving parts such as an electric motor, a gear box, etc. are disposed at a front sub-frame. A next-generation electric vehicle has a tendency toward an increase in passenger compartment size to realize autonomous driving and innovative user experience and, as such, a front space of the vehicle is relatively reduced. When the front space of the vehicle is reduced, the space for absorbing collision energy generated during a front or offset collision is correspondingly reduced.

In particular, a sub-frame may be separated from the vehicle body or is fractured during the front or offset collision of the vehicle and, as such, electric driving parts mounted to the sub-frame or an upper end of the sub-frame may strike a battery, thereby causing the battery to be damaged.

The above matters disclosed in this section are merely for enhancement of understanding of the general background of the present disclosure and should not be taken as an acknowledgement or any form of suggestion that the matters form the related art already publicly known, available, or in use.

### SUMMARY

The present disclosure relates to a vehicle body assembly disposed under a front floor of a vehicle body and configured through inclusion of a slider configured to cover a front side of a battery, and a rear cross member disposed at a rear side of the slider and coupled to a lower portion of the front floor of the vehicle body to support the slider at the rear side of the slider, thereby being capable of preventing application of impact to the battery through a front sub-frame when collision of a vehicle occurs.

Therefore, an embodiment of the present disclosure has been made in view of the above problems, and an embodiment of the present disclosure can provide a vehicle body assembly disposed under a front floor of a vehicle body and configured through inclusion of a slider configured to cover a front side of a battery, and a rear cross member disposed at a rear side of the slider and coupled to a lower portion of the front floor of the vehicle body to support the slider at a rear side of the slider, wherein the slider is disposed at a rear side of a front sub-frame of a vehicle, thereby preventing the front sub-frame from approaching the battery.

Advantages of an embodiment of the present disclosure are not limited to the above-described advantages, and other advantages of an embodiment of the present disclosure not yet described can be more clearly understood by those skilled in the art from the following detailed description.

In accordance with embodiments of the present disclosure, a vehicle body assembly including a slider disposed under a front floor of a body of a vehicle and configured to cover a front side of a battery, and a rear cross member disposed at a rear of the slider and coupled to a lower portion of the front floor of the vehicle body under the front floor to support the slider at the rear of the slider, wherein the slider is disposed at a rear of a front sub-frame of the vehicle to prevent the front sub-frame from approaching the battery when collision of the vehicle occurs.

In an embodiment of the vehicle body assembly of the present disclosure, a slope surface may be formed at a front portion of the slider such that, when collision of the vehicle occurs, the front sub-frame disposed in front of the slider may be guided downwards along the slope surface of the slider.

In an embodiment of the vehicle body assembly of the present disclosure, the front sub-frame may be coupled, at a rear end thereof, to the lower portion of the front floor under the front floor, and the slider may cover the rear end of the front sub-frame under the front sub-frame.

In an embodiment of the vehicle body assembly of the present disclosure, when collision of the vehicle occurs, the front sub-frame may be fractured in front of a point where the front sub-frame is coupled to the lower portion of the front floor of the vehicle body under the front floor, and may then be guided downwards by the slider.

In an embodiment of the vehicle body assembly of the present disclosure, the slider and the battery may be fastened to each other under a condition that a rear surface of the slider and a front surface of the battery surface-contact each other.

In an embodiment of the vehicle body assembly of the present disclosure, a protrusion may be formed at an upper end of the slider to protrude toward the rear cross member, and may be disposed to face a front surface of the rear cross member.

In an embodiment of the vehicle body assembly of the present disclosure, the slider may be a hollow member extruded in a width direction of the vehicle body.

In an embodiment of the vehicle body assembly of the present disclosure, a plurality of ribs may be integrally formed at a cavity of the slider to extend in the width direction of the vehicle body while being vertically spaced apart from one another.

In an embodiment of the vehicle body assembly of the present disclosure, the slider may include a support disposed under the front floor of the vehicle body, and a cover disposed under the front sub-frame while extending from the support.

In an embodiment of the vehicle body assembly of the present disclosure, a protrusion may be formed at the support to protrude toward the rear cross member, a cover may extend from the support in a width direction of the vehicle body to cover a rear end of the front sub-frame under the front sub-frame, and a slope surface may be formed at front portions of the support and the cover.

In an embodiment of the vehicle body assembly of the present disclosure, the slider may be provided in plural such that the plurality of sliders is disposed to be spaced apart from one another in the width direction of the vehicle body.

In an embodiment of the vehicle body assembly of the present disclosure, the rear cross member may be disposed over the battery such that a lower surface of the rear cross member is fastened to an upper surface of the battery in a state of surface-contacting each other.

In an embodiment of the vehicle body assembly of the present disclosure, a pair of floor lower members extending in a longitudinal direction of the vehicle body may be formed at the lower portion of the front floor of the vehicle body while being spaced apart from in a width direction of the vehicle body, and the rear cross member may be coupled, at opposite ends thereof, to the pair of floor lower members, respectively, to be fixed.

In an embodiment of the vehicle body assembly of the present disclosure, the vehicle body assembly may further include a front cross member coupled to the lower portion of the front floor of the vehicle body under the front floor while being disposed such that the front cross member is located in front of the rear cross member and over the slider, thereby supporting the slider over the sider.

In an embodiment of the vehicle body assembly of the present disclosure, the front cross member and the slider may be coupled to each other under a condition that a lower surface of the front cross member and an upper surface of the slider surface-contact each other.

In an embodiment of the vehicle body assembly of the present disclosure, a protrusion may be formed at a rear end of an upper surface of the slider to extend diagonally toward the rear cross member.

In an embodiment of the vehicle body assembly of the present disclosure, a protrusion may be formed at an upper portion of the slider to extend toward the rear cross member, and the protrusion may be disposed between the rear cross member and the front cross member.

### BRIEF DESCRIPTION OF THE DRAWINGS

The above and other features and advantages of example embodiments of the present disclosure can be more clearly understood from the following detailed description taken in conjunction with the accompanying drawings, in which:

FIG. 1 is a view of a vehicle body assembly according to an embodiment of the present disclosure viewed from the lateral side;

FIG. 2 is a view of a vehicle body assembly according to an embodiment of the present disclosure viewed from the lateral bottom side;

FIG. 3 is a view of a vehicle body assembly according to an embodiment of the present disclosure viewed from the bottom side;

FIG. 4 is a view explaining a main load path of a vehicle body assembly according to an embodiment of the present disclosure, and a rear cross member and a front cross member coupled to the main load path;

FIG. 5 is a perspective view showing a slider according to an embodiment of the present disclosure; and

FIG. 6 is a view of a slider according to an embodiment of the present disclosure viewed from the top side.

### DETAILED DESCRIPTION OF ILLUSTRATIVE EMBODIMENTS

In the following description of example embodiments of the present disclosure, a detailed description of known technologies incorporated herein can be omitted when it may obscure the subject matter of the example embodiments of the present disclosure. In addition, example embodiments of the present disclosure can be more clearly understood from the accompanying drawings and are not necessarily limited by the accompanying drawings, and it can be appreciated that changes, equivalents, and substitutes that do not depart from the spirit and technical scopes of the present disclosure can be encompassed in the present disclosure.

It can be understood that, although the terms “first”, “second”, etc. may be used herein to describe various elements, these elements are not necessarily limited by these terms. These terms can be used merely to distinguish one element from another.

Unless clearly used otherwise, singular expressions can include a plural meaning.

In this specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

In the case where an element is “connected” or “linked” to another element, it can be understood that the element may be directly connected or linked to the other element, or another element may be present therebetween. Conversely, in the case where an element is “directly connected” or “directly linked” to another element, it can be understood that no other element is present therebetween.

Because parts associated with driving of a vehicle, such as wheels, a suspension, a motor, etc., can be mounted to a front sub-frame, the front sub-frame can be disposed at a lower portion of the vehicle and can be disposed at a level similar to that of a passenger compartment of the vehicle. Therefore, for safety, it can be important to prevent the front sub-frame from penetrating the passenger compartment after being fractured when collision of the vehicle occurs. When a fractured front sub-frame (as described above) strikes a battery of the vehicle, the battery may be damaged. To this end, when front or offset collision of the vehicle occurs, the front sub-frame separated from a vehicle body in a fractured state should be prevented from penetrating the battery. When the fractured front sub-frame is upwardly guided to prevent penetration thereof into the battery, the fractured front sub-frame may penetrate the passenger compartment and, as such, may cause a very dangerous situation. Therefore, the safety of the passenger compartment can be secured by guiding the fractured front sub-frame to an area under the battery while preventing penetration of the fractured front sub-frame into the battery, to prevent the fractured front sub-frame from striking the battery and from penetrating the passenger compartment. To this end, improvement of a vehicle body assembly capable of satisfying the above-described requirements can be achieved with an embodiment of the present disclosure.

Therefore, an embodiment of the present disclosure can provide a vehicle body assembly configured to prevent the front sub-frame from approaching the battery, thereby protecting the battery, when collision of the vehicle occurs, through inclusion of a slider configured to cover a front side of the battery and a rear cross member configured to support the slider at a rear side of the slider.

Hereinafter, example embodiments of the present disclosure will be described in detail with reference to the accompanying drawings, and same or similar elements can be designated by same reference numerals regardless of the numerals in the drawings and redundant description thereof can be omitted.

Although an electric vehicle is illustrated as a vehicle that will be shown and described hereinafter, embodiments of the present disclosure can be applicable to a variety of vehicles configured such that a battery is coupled to a lower portion of a vehicle body, such as an electric vehicle, a fuel cell vehicle, a hybrid vehicle, etc. That is, it can be understood that any vehicle can fall within scopes of the present disclosure, such as where a battery is coupled to a lower portion of a vehicle body at a front side of the vehicle body.

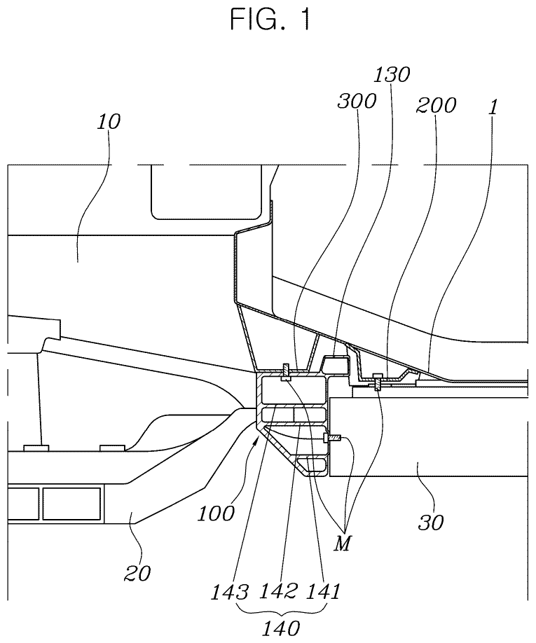

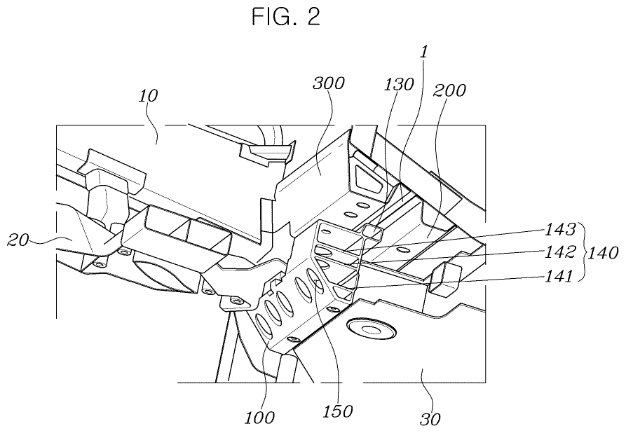

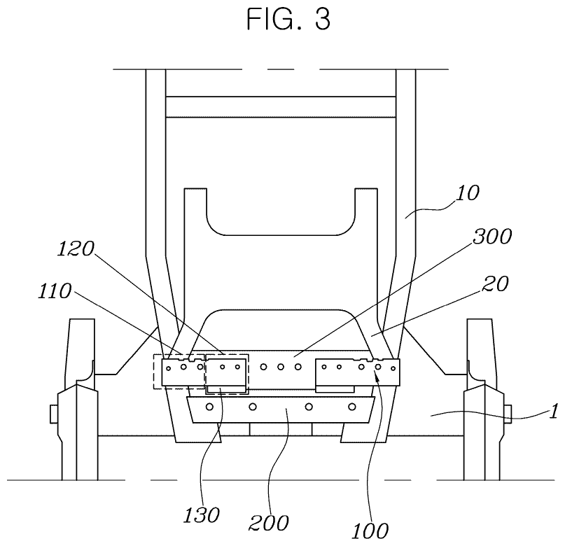

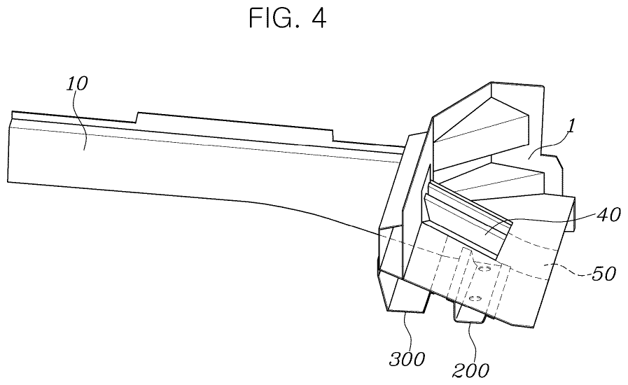

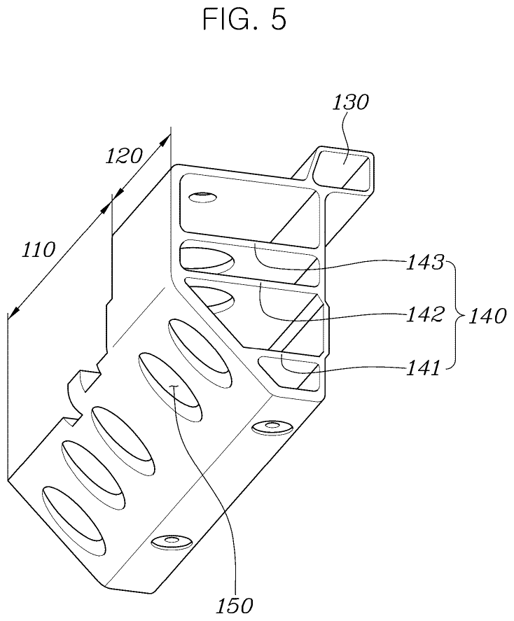

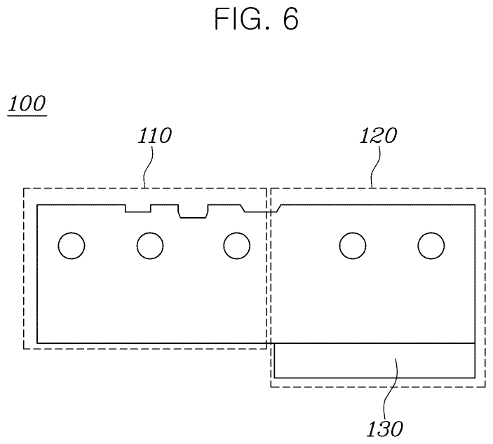

FIG. 1 is a view of a vehicle body assembly according to an embodiment of the present disclosure viewed from the lateral side. FIG. 2 is a view of a vehicle body assembly according to an embodiment of the present disclosure viewed from the lateral bottom side. FIG. 3 is a view of a vehicle body assembly according to an embodiment of the present disclosure viewed from the bottom side. FIG. 4 is a view explaining a main load path of a vehicle body assembly according to an embodiment of the present disclosure, and a rear cross member and a front cross member coupled to the main load path. FIG. 5 is a perspective view showing a slider according to an embodiment of the present disclosure. FIG. 6 is a view of a slider according to an embodiment of the present disclosure viewed from the top side. Hereinafter, the vehicle body assembly of example embodiments of the present disclosure will be described with reference to the accompanying drawings.

A vehicle body assembly according to an embodiment of the present disclosure can include a slider 100 disposed under a front floor 1 of a body of a vehicle and configured to cover a front side of a battery 30, and a rear cross member 200 disposed at a rear of the slider 100 and coupled to a lower portion of the front floor 1 of the vehicle body under the front floor 1 to support the slider 100 at the rear of the slider 100. The slider 100 can be disposed at a rear of a front sub-frame 20 of the vehicle and, as such, may prevent the front sub-frame 20 from approaching the battery 30 when collision of the vehicle occurs.

In the embodiment shown in FIGS. 1 and 2, the front sub-frame 20 may be coupled to a lower portion of the front floor 1 under the front floor 1 and may be coupled to a front side member 10 of the vehicle body. The slider 100 may cover a rear end of the front sub-frame 20 under the front sub-frame 20. When collision of the vehicle occurs, the front sub-frame 20 may be fractured in front of a point where the front sub-frame 20 is coupled to the lower portion of the front floor 1 of the vehicle body under the front floor 1, and may then be guided downwards by the slider 100.

In the embodiment shown in FIGS. 1 and 2, a slope surface inclined downwards may be formed at a front portion of the slider 100. The slope surface may be formed at a part or the entirety of the front portion of the slider 100. When collision of the vehicle occurs, the front sub-frame 20 disposed in front of the slider 100 is guided downwards along the slope surface of the slider 100 and, as such, may be prevented from striking the battery 30.

In the embodiment shown in FIG. 1, the slider 100 may be coupled to the front cross member 300 disposed thereover in a state in which a lower surface of the front cross member 300 surface-contacts the entirety or a part of an upper surface of the slider 100. The front cross member 300 and the slider 100 may be coupled to each other in various manners such as bonding, welding, mechanical fastening, etc., and may be firmly fastened to each other through, for example, mounting bolts M. The slider 100 is more firmly fixed to the vehicle body through the above-described structure and, as such, may effectively withstand collision energy generated when collision of the vehicle occurs and impact caused by the front sub-frame 20 due to the collision energy. In this case, accordingly, the slider 100 may effectively protect the battery 30 disposed in rear thereof.

In the embodiment shown in FIGS. 1 and 2, a protrusion 130 may be formed at an upper end of the slider 100 to protrude toward the rear cross member 200. The protrusion 130 may be formed at a rear end of the upper surface of the slider 100 to extend diagonally toward the rear cross member 200 such that the protrusion 130 is disposed between the front cross member 300 and the rear cross member 200. Through this structure, the protrusion 130 can be disposed to face the front surface of the rear cross member 200 even under the condition that the upper surface of the slider 100 surface-contacts the front cross member 300. Accordingly, when collision of the vehicle occurs, the slider 100 may be supported by the rear cross member 200 and, as such, rearward pushing of the slider 100 may be prevented. In addition, the protrusion 130 can be disposed to face a rear surface of the front cross member 300 and, as such, the front cross member 300 may be prevented from approaching the battery 30 by the protrusion 130 of the slider 100 when collision of the vehicle occurs.

In the embodiment shown in FIGS. 5 and 6, a slider 100 may include a support 120, and a cover 110 extending from the support 120. A protrusion 130 may be formed at an upper end of the support 120 to protrude upwards. The protrusion 130 may have a hollow structure to reduce weight.

In the embodiment shown in FIG. 3, the slider 100 may include a support 120 disposed under the front floor 1 of the vehicle body, and a cover 110 disposed under the front sub-frame 20 while extending from the support 120. In detail, the cover 110 can extend from the support 120 in a width direction of the vehicle body to cover the rear end of the front sub-frame 20 under the front sub-frame 20. The protrusion 130 may be formed at the support 120 to protrude toward the rear cross member 200.

In the vehicle body assembly according to an embodiment of the present disclosure, the slider 100 may be made of a material capable of securing a predetermined strength or more, such as a metal material, engineering plastic, a composite material, or the like. The slider 100 may extend in the width direction of the vehicle body, and may have a hollow structure while using a lightweight metal such as aluminum, for lightness. Ribs 140 may be formed at a cavity of the slider 100 to reinforce stiffness of the hollow structure of the slider 100.

In both embodiments of FIGS. 2 and 5, the slider 100 may be a hollow member extruded in the width direction of the vehicle body, and a plurality of ribs 140 may be integrally formed at an inside of the slider 100 to extend in the width direction of the vehicle body while being vertically spaced apart from one another. The ribs 140 may include a first rib 141 configured to support the slope surface of the slider 100, a second rib 142 configured to support a bent point of the slider 100 at the front portion of the slider 100, and a third rib 143 configured to support an upper part of the front portion of the slider 100. Through this structure, the ribs 140 may firmly support the slope surface of the slider 100. When collision of the vehicle occurs, the slider 100 may maintain the shape thereof formed with the slope surface at the front portion thereof in accordance with the above-described structure and, as such, may guide the front sub-frame 20 in a downward direction, thereby effectively protecting the battery 30 disposed in rear thereof. Through the hollow structure of the slider 100, it may be possible to achieve weight reduction and, as such, to enhance fuel economy.

Through holes 150 may be formed at the slope surface formed at the front portion of the slider 100. A plurality of through holes 150 may be formed at the ribs 140 of the slider 100 to be aligned with the through holes 150 formed at the slope surface, respectively. The through holes 150 may be formed in at least a part of the ribs 140. The inside of the slider 100 may communicate with an outside of the slider 100 through the through holes 150. In detail, a fastening mechanism or the like may be inserted into the inside of the slider 100 to firmly couple the slider 100 to the front cross member 300 or the rear cross member 200.

In the embodiment shown in FIG. 3, left and right ends of the front sub-frame 20 may be coupled to the lower portion of the front floor 1 of the vehicle body under the front floor 1. The slider 100 may be provided in plural such that the plurality of sliders 100 are disposed to be spaced apart from one another in the width direction of the vehicle body. In this case, a pair of sliders 100 may cover the left and right ends of the front sub-frame 20, respectively. As the sliders 100 can be provided in an area where the front sub-frame 20 is coupled to the lower portion of the front floor 1 of the vehicle body, it may be possible to exclude application of sliders 100 to an area where sliders 100 are unnecessary while preventing the front sub-frame 20 from approaching the battery 30 when collision of the vehicle occurs. In this regard, lightness of the vehicle body assembly may be achieved.

FIG. 1 is a view of a vehicle body assembly according to an embodiment of the present disclosure viewed from the lateral side. FIG. 2 is a view of a vehicle body assembly according to an embodiment of the present disclosure viewed from the lateral bottom side. FIG. 3 is a view of a vehicle body assembly according to an embodiment of the present disclosure viewed from the bottom side. FIG. 4 is a view explaining a main load path of a vehicle body assembly according to an embodiment of the present disclosure, and a rear cross member and a front cross member coupled to the main load path. Hereinafter, the rear cross member of an example embodiment of the present disclosure will be described with reference to the drawings described above.

In a vehicle assembly according to an embodiment of the present disclosure, the rear cross member 200 can be disposed at the rear of the slider 100 while being coupled to the lower portion of the front floor 1 of the vehicle body under the front floor 1 and, as such, may support the slider 100 at a rear side thereof.

In the embodiment shown in FIGS. 1 and 2, the rear cross member 200 may be manufactured through a plate pressing process, and may be coupled to the lower portion of the front floor 1 under the front floor 1 such that a cavity may be formed at an inside thereof. Accordingly, both structural robustness and lightness may be achieved.

The rear cross member 200 may be disposed over the battery 30 such that a lower surface of the rear cross member 200 is coupled to an upper surface of the battery 30 in a state of surface-contacting each other. The rear cross member 200 and the battery 30 may be coupled to each other in various manners such as bonding, welding, mechanical fastening, etc., and may be firmly fastened to each other through, for example, mounting bolts M. Through such a structure, the battery 30 may be more firmly coupled to the lower portion of the front floor 1 of the vehicle body under the front floor 1.

In the vehicle body assembly of the embodiment shown in FIG. 4, a main load path of the vehicle may be formed through a configuration including the front side member 10 coupled to the front floor 1 of the vehicle body, a floor lower member 50 coupled to the lower portion of the front floor 1 of the vehicle body, and a floor upper member 40 coupled to an upper portion of the front floor 1 of the vehicle body.

In each embodiment shown in FIGS. 3 and 4, a pair of floor lower members 50 is formed at a front end of the lower portion of the front floor 1 of the vehicle body to be spaced apart from each other in the width direction of the vehicle body while being connected to the front side member 10 extending in a longitudinal direction of the vehicle body. In this case, the rear cross member 200 is coupled, at opposite ends thereof, to the pair of floor lower members 50, respectively, and, as such, may be fixed while being disposed at a rear of the front cross member 300 and the slider 100. Accordingly, the rear cross member 200 can be coupled to the floor lower member 50 forming the above-described main load path and, as such, may be more firmly coupled to the lower portion of the front floor 1 of the vehicle body under the front floor 1.

FIG. 1 is a view of a vehicle body assembly according to an embodiment of the present disclosure viewed from the lateral side. FIG. 2 is a view of a vehicle body assembly according to an embodiment of the present disclosure viewed from the lateral bottom side. FIG. 3 is a view of a vehicle body assembly according to an embodiment of the present disclosure viewed from the bottom side. FIG. 4 is a view explaining a main load path of a vehicle body assembly according to an embodiment of the present disclosure, and a rear cross member and a front cross member coupled to the main load path. Hereinafter, the vehicle body assembly of an example embodiment of the present disclosure will be described mainly in conjunction with the front cross member with reference to the drawings descried above.

A vehicle body assembly according to an embodiment of the present disclosure may further include the front cross member 300 that can be coupled to the lower portion of the front floor 1 of the vehicle body under the front floor 1 while being disposed such that the front cross member 300 is located in front of the rear cross member 200 and over the slider 100, thereby supporting the slider 100 over the slider 100.

In the embodiment shown in FIG. 1, the front cross member 300 is coupled to the lower portion of the front floor 1 of the vehicle body under the front floor 1, and is disposed in front of the rear cross member 200 and over the slider 100. As the front cross member 300 is coupled to the lower portion of the front floor 1 of the vehicle body under the front floor 1, the front cross member 300 may support the slider 100 over the slider 100.

The front cross member 300 may be disposed over the slider 100 such that a lower surface of the front cross member 300 is coupled to an upper surface of the slider 100 in a state of surface-contacting each other. The front cross member 300 and the slider 100 may be coupled to each other in various manners such as bonding, welding, mechanical fastening, etc., and may be firmly fastened to each other through, for example, mounting bolts M. Through such a structure, the slider 100 may be more firmly coupled to the lower portion of the front floor 1 of the vehicle body under the front floor 1.

In the embodiment shown in FIGS. 1 and 2, the front cross member 300 may be manufactured through a plate pressing process, and may be coupled to the lower portion of the front floor 1 of the vehicle body under the front floor 1 such that a cavity may be formed at an inside thereof. Accordingly, both structural robustness and lightness may be achieved.

In a vehicle body assembly according to an embodiment of the present disclosure, a main load path extending in a longitudinal direction of a vehicle may be formed. The main load path may be constituted by a front side member 10 coupled to a vehicle body of the vehicle body assembly, a floor lower member 50 coupled to a lower portion of the front floor 1 of the vehicle body, and a floor upper member 40 coupled to an upper portion of the front floor 1 of the vehicle body. A front cross member may be coupled to the front side member 10 or the floor lower member 50 forming the above-described main load path and, as such, may be more firmly coupled to the lower portion of the front floor 1 under the front floor 1.

In each embodiment shown in FIGS. 3 and 4, an end of the front side member 10 may be coupled to the lower portion of the front floor 1 of the vehicle body under the front floor 1. Opposite ends of the front cross member 300 may be coupled to the front side member 10 and, as such, may be fixed while being disposed in front of the rear cross member 200. Through this structure, the front cross member 300 may be more firmly coupled to the lower portion of the front floor 1 under the front floor 1.

As apparent from the above description, in accordance with an embodiment of a vehicle body assembly of the present disclosure, the front sub-frame of the vehicle can be prevented from approaching the battery when front or offset collision of the vehicle occurs, thereby preventing damage to the battery. Through such a structure of the vehicle body assembly, it may be possible to reduce a space for absorbing collision energy of the vehicle and, as such, to increase size of the passenger compartment and the capacity of the battery.

Effects attainable in the present disclosure are not limited to the above-described effects, and other effects of the present disclosure not yet described will be more clearly understood by those skilled in the art from the above detailed description.

Although the example embodiments of the present disclosure have been disclosed for illustrative purposes, those skilled in the art can appreciate that various modifications, additions, and substitutions can be possible, without departing from the scopes and spirit of the present disclosure as disclosed in the accompanying claims.

What is claimed is:

1. A vehicle body assembly comprising:
a slider disposed under a front floor of a vehicle body of a vehicle and configured to cover a front side of a battery; and
a rear cross member disposed at a rear of the slider and coupled to a lower portion of the front floor of the vehicle body under the front floor to support the slider at the rear of the slider,
wherein the slider is disposed at a rear of a front sub-frame of the vehicle and configured to prevent the front sub-frame from approaching the battery when collision of the vehicle occurs.

2. The vehicle body assembly of claim 1, wherein a slope surface is at a front portion of the slider and configured such that, when collision of the vehicle occurs, the front sub-frame disposed in front of the slider is guided downwards along the slope surface of the slider.

3. The vehicle body assembly of claim 1, wherein the front sub-frame is coupled, at a rear end thereof, to the lower portion of the front floor under the front floor, and the slider covers the rear end of the front sub-frame under the front sub-frame.

4. The vehicle body assembly of claim 1, wherein the slider and the battery are fastened to each other under a condition that a rear surface of the slider and a front surface of the battery surface-contact each other.

5. The vehicle body assembly of claim 1, wherein a protrusion extends at an upper end of the slider to protrude toward the rear cross member, and the protrusion is disposed to face a front surface of the rear cross member.

6. The vehicle body assembly of claim 1, wherein the slider is a hollow member extruded in a width direction of the vehicle body.

7. The vehicle body assembly of claim 6, wherein a plurality of ribs are integrally formed at a cavity of the slider to extend in the width direction of the vehicle body while being vertically spaced apart from one another.

8. The vehicle body assembly of claim 1, wherein the slider comprises:
a support disposed under the front floor of the vehicle body; and
a cover disposed under the front sub-frame while extending from the support.

9. The vehicle body assembly of claim 8, wherein a protrusion extends at the support to protrude toward the rear cross member, the cover extends from the support in a width direction of the vehicle body to cover a rear end of the front sub-frame under the front sub-frame, and a slope surface is at front portions of the support and the cover.

10. The vehicle body assembly of claim 1, wherein the rear cross member is disposed over the battery such that a lower surface of the rear cross member is fastened to an upper surface of the battery in a state of surface-contacting each other.

11. The vehicle body assembly of claim 1, wherein a pair of floor lower members extending in a longitudinal direction of the vehicle body are located at the lower portion of the front floor of the vehicle body while being spaced apart from each other in a width direction of the vehicle body, and the rear cross member is coupled, at opposite ends thereof, to the pair of floor lower members, respectively, to be fixed.

12. The vehicle body assembly of claim 1, further comprising a front cross member coupled to the lower portion of the front floor of the vehicle body under the front floor while being disposed such that the front cross member is located in front of the rear cross member and over the slider, thereby supporting the slider over the slider.

13. The vehicle body assembly of claim 12, wherein the front cross member and the slider are coupled to each other under a condition that a lower surface of the front cross member and an upper surface of the slider surface-contact each other.

14. The vehicle body assembly of claim 12, wherein a protrusion is at a rear end of an upper surface of the slider to extend diagonally toward the rear cross member.

15. The vehicle body assembly of claim 14, wherein the protrusion is disposed between the rear cross member and the front cross member.

16. A vehicle body assembly comprising:
a slider disposed under a front floor of a vehicle body of a vehicle and configured to cover a front side of a battery, wherein the slider is disposed at a rear of a front sub-frame of the vehicle;
a rear cross member disposed at a rear of the slider and coupled to a lower portion of the front floor of the vehicle body under the front floor to support the slider at the rear of the slider;
a front cross member coupled to the lower portion of the front floor of the vehicle body under the front floor while being disposed such that the front cross member is located in front of the rear cross member and over the slider, wherein the front cross member supports the slider; and
a protrusion at a rear end of an upper surface of the slider to extend diagonally toward the rear cross member, wherein the protrusion is disposed between the rear cross member and the front cross member.

17. The vehicle body assembly of claim 16, wherein the slider is configured to prevent the front sub-frame from approaching the battery when collision of the vehicle occurs.

18. A vehicle body assembly comprising:
a slider disposed under a front floor of a vehicle body of a vehicle and configured to cover a front side of a battery, wherein the slider is disposed at a rear of a front sub-frame of the vehicle;
a rear cross member disposed at a rear of the slider and coupled to a lower portion of the front floor of the vehicle body under the front floor to support the slider at the rear of the slider;
a front cross member coupled to the lower portion of the front floor of the vehicle body under the front floor while being disposed such that the front cross member is located in front of the rear cross member and over the slider, wherein the front cross member supports the slider;
a protrusion at a rear end of an upper surface of the slider to extend diagonally toward the rear cross member, wherein the protrusion is disposed between the rear cross member and the front cross member, wherein the protrusion is disposed to face a front surface of the rear cross member; and
a slope surface at a front portion of the slider and configured such that, when a collision of the vehicle occurs, the front sub-frame disposed in front of the slider can be guided downwards along the slope surface of the slider, and wherein the slider is configured to prevent the front sub-frame from approaching the battery when the collision of the vehicle occurs.

19. The vehicle body assembly of claim 18, further comprising a pair of floor lower members extending in a longitudinal direction of the vehicle body are at the lower portion of the front floor of the vehicle body while being spaced apart from each other in a width direction of the vehicle body, and wherein the rear cross member is coupled, at opposite ends thereof, to the pair of floor lower members, respectively, to be fixed;
wherein the slider comprises:
a support disposed under the front floor of the vehicle body, and
a cover disposed under the front sub-frame while extending from the support, wherein the cover extends from the support in a width direction of the vehicle body to cover a rear end of the front sub-frame under the front sub-frame;
wherein the front sub-frame is coupled, at the rear end thereof, to the lower portion of the front floor under the front floor, and the slider covers the rear end of the front sub-frame under the front sub-frame;
wherein the slider and the battery are fastened to each other under a condition that a rear surface of the slider and a front surface of the battery surface-contact each other;
wherein the slider is a hollow member extruded in the width direction of the vehicle body; and
wherein a plurality of ribs are integrally formed at a cavity of the slider to extend in the width direction of the vehicle body while being vertically spaced apart from one another.

20. The vehicle body assembly of claim 19, wherein the rear cross member is disposed over the battery such that a lower surface of the rear cross member is fastened to an upper surface of the battery in a state of surface-contacting each other, and
wherein the front cross member and the slider are coupled to each other under a condition that a lower surface of the front cross member and an upper surface of the slider surface-contact each other.
